(19) United States
(12) Patent Application Publication
(10) Pub. No.: US 2016/0071669 A1
(43) Pub. Date: Mar. 10, 2016

(54) Arrangement for an Electrical Circuit Element With a Seal Configuration

(71) Applicant: TE Connectivity Germany GmbH, Bensheim (DE)

(72) Inventors: Thomas Haehnel, Berlin (DE); Albert Koetter, Berlin (DE); Christian Maranke, Luechfeld (DE); Rene Wagner, Berlin (DE); Titus Ziegler, Berlin (DE)

(73) Assignee: TE CONNECTIVITY GERMANY GMBH, Bensheim (DE)

(21) Appl. No.: 14/943,592

(22) Filed: Nov. 17, 2015

Related U.S. Application Data
(63) Continuation of application No. PCT/EP2014/061011, filed on May 28, 2014.

(30) Foreign Application Priority Data
May 31, 2013 (DE) 102013210194.5

(51) Int. Cl. H01H 33/04

(52) U.S. Cl. CPC H01H 33/04

(57) ABSTRACT

An electrical circuit element is disclosed. The electrical circuit element has an interrupter having contacts and an opening, a propulsion element extending through the opening in the interrupter and having an annular flange, and a seal configuration having an annular ring surrounding the opening. The propulsion element is movable within the opening to open or close the contacts, and in an end position of the propulsion element, the annular flange abuts the annular ring.

### CROSS-REFERENCE TO RELATED APPLICATIONS

This application is a continuation of PCT/EP2014/061011 filed May 28, 2014, which claims priority under 35 U.S.C. §119 to German Patent No. 102013210194.5 filed May 31, 2013.

### FIELD OF THE INVENTION

The invention concerns an electrical circuit element, and more particularly, an electrical circuit element with an interrupter.

### BACKGROUND

Electrical circuit elements such as relays or contactors are standard components that have long been used in electrical engineering. When the contacts are opened, in particular at high current strength, arcs frequently form between the contacts. Arc formation is problematic on the one hand because the arcs are conduits, such that, as long as an arc is present, the electrical circuit is not interrupted, and, on the other, because the hot plasma of the arc may damage the components of the electrical circuit element both inside and outside of the interrupter. This results in a reduced useful life of the circuit elements.

### SUMMARY

The object of the invention is to provide an arrangement for an electrical circuit element that facilitates the elimination of any arcs and increases the useful life of the circuit without increasing manufacture costs. The disclosed electrical circuit element has an interrupter having contacts and an opening, a propulsion element extending through the opening in the interrupter and having an annular flange, and a seal configuration having an annular ring surrounding the opening. The propulsion element is movable within the opening to open or close the contacts, and in an end position of the propulsion element, the annular flange abuts the annular ring.

### BRIEF DESCRIPTION OF THE DRAWINGS

The invention will now be described by way of example with reference to the accompanying figures, of which:

FIG. 1 is a cross-section of part of an electrical circuit element according to a first embodiment of the invention;

FIG. 2 is a cross-section of a seal configuration according to the first embodiment;

FIG. 3 is cross-section of a seal configuration according to a second embodiment of the invention;

FIG. 4 is a cross-section of a seal configuration according to a third embodiment of the invention;

FIG. 5 is a cross-section of a seal configuration according to a fourth embodiment of the invention.

### DETAILED DESCRIPTION OF THE EMBODIMENT(S)

The invention is explained in greater detail below with reference to embodiments of an electrical circuit element. This invention may, however, be embodied in many different forms and should not be construed as limited to the embodiments set forth herein; rather, these embodiments are provided so that this disclosure will be thorough and complete and still fully convey the scope of the invention to those skilled in the art.

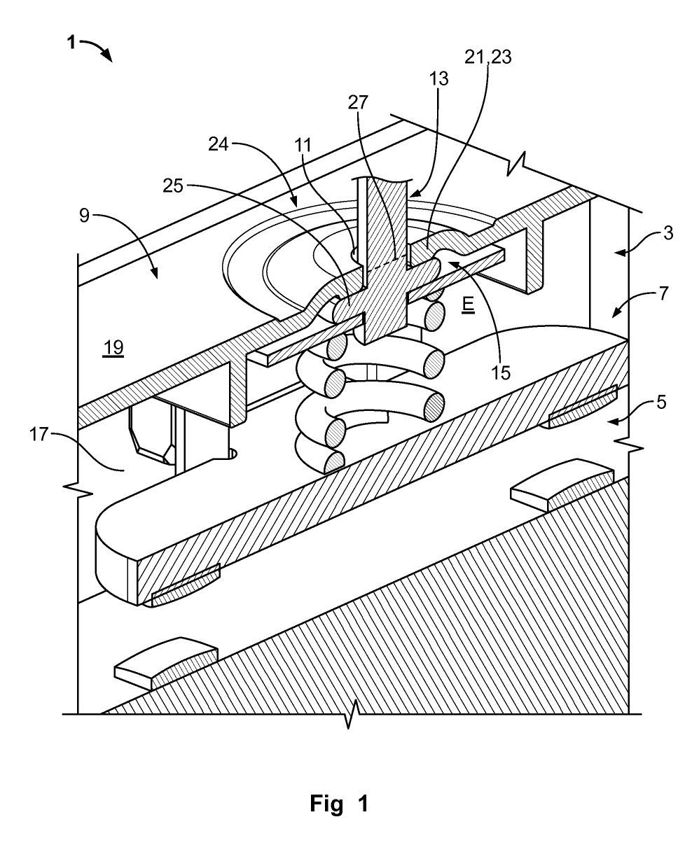

FIG. 1 shows an embodiment of an arrangement of an electrical circuit element 1 according to the invention in cross-section. The arrangement for an electrical circuit element 1 comprises an interrupter 3. The interrupter 3 contains contacts 5. The contact arrangement 7 shown, which is configured in the form of a contact bridge to connect two contacts 5, is meant merely as an example of contacts 5 capable of opening and/or closing.

The interrupter 3 has a wall 9, which has an opening 11. A propulsion element 13 protrudes through the opening 11 into the interrupter 3. The propulsion element 13 is functionally coupled with the contacts 5. In FIG. 1, the propulsion element 13 is in its end position E. The propulsion element 13 is surrounded by the seal configuration 15. In the end position E of the propulsion element 13, the opening 11 is sealed by the seal configuration 15. The inside 17 of the interrupter 3 is separated from the area 19 outside the interrupter in the end position E.

The seal configuration 15 includes a stationary part 21 of the wall 9 and an annular flange 25 of the propulsion element 13.

The stationary part 21 extends annularly around the opening 11, and is formed as an annular ring 23. The stationary part 21 is part of the wall section 24, which also contains the opening 11. The ring 23 is formed so as to thicken the wall 9 in this exemplary embodiment. However, the ring 23 may also be formed by an additional element that abuts the wall 9. The ring 23 protrudes into the interrupter 3.

The annular flange 25 on the propulsion element 13 protrudes in parallel to a plane 27 of the opening 11. The annular flange 25 may be integrally formed with the propulsion element 13.

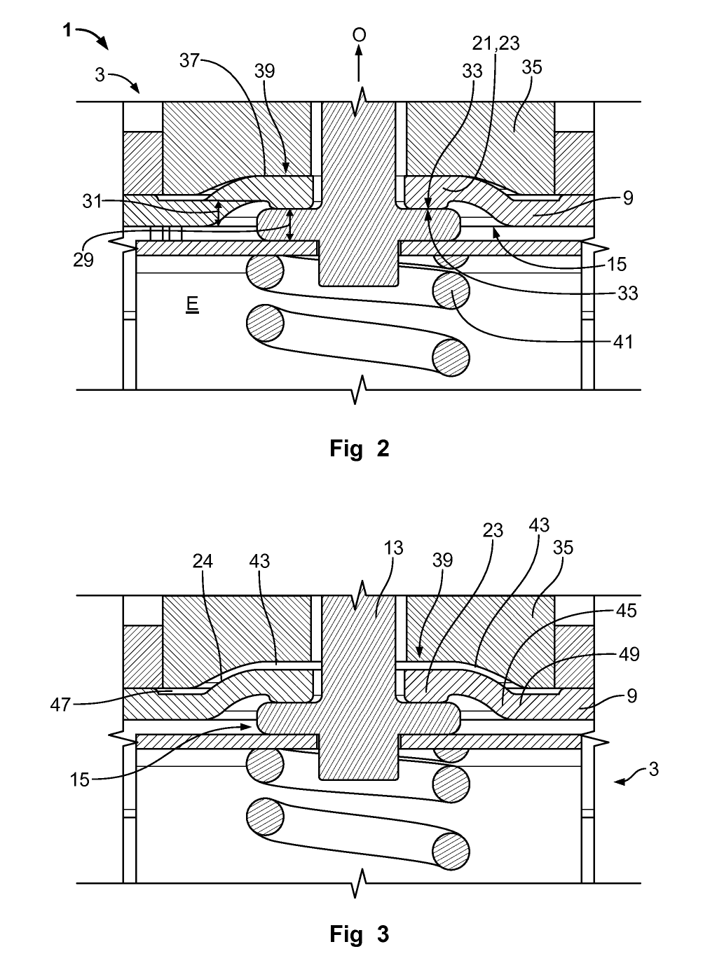

The structure and function of the seal configuration 15 are further described in FIG. 2. FIG. 2 shows an enlargement of the seal configuration 15 according to the invention from FIG. 1 in cross-section.

The annular flange 25 abuts the annular ring 23 in the end position E, and completely overlaps with the opening 11. This completely seals the interrupter 3. The side of the flange 25 facing the stationary part 21 forms a sealing surface 33; the side of the ring 23 facing the flange 25 forms the sealing surface 33′. In the end position E, the sealing surfaces 33 and 33′ abut each other, thus sealing the interrupter 3. Further, in the end position E, the section 24 having the opening 11 is positioned apart from the interrupter 3 by a distance 31. This distance 31 roughly corresponds to the thickness 29 of the flange 25.

A support element 35 of the circuit element 1 may abut an outer side 37 of the section 24 on the interrupter 3.

The functioning of the seal configuration 15 will now be described. The propulsion element 13 begins in a switching position (not shown), in which the contacts 5 are closed. If the contacts are opened and an arc (not shown) forms within the interrupter 3, the gas heated by the arc inside the interrupter 3 seeks to leave the interrupter 3 via the opening 11. The pressure of the gas forces the propulsion element 13 along the opening direction O into the end position E; the annular ring 23 may serve as a stop for the flange 25, thus defining the end position E of the propulsion element 13. The end position E is reached by the propulsion element 13 when the opening of the contacts 5 is complete.

In order to reduce the stress on the material of the wall section 24 when the flange 25 collides with the ring 23, the support element 35 abutting an outer side 37 of the section 24 may absorb part of the kinetic energy of the propulsion element 13.

The circuit element 1 may have a damping configuration 39. In a particularly simply produced embodiment, the ring 23 is part of the damping configuration 39. To this end, the ring 23 may be made of a soft or elastic material, or the wall section 24 may be made of an elastic material. The wall section 24 and the annular ring 23 may be produced by means of multi-component injection moulding, whereby the annular ring 23 may be made of a more elastic material than the rest of the wall section 24.

In a variation (not shown), the flange 25 may directly abut a spring element 41 of the circuit element 1. The side of the flange 25 facing away from the wall 9 may be configured such that the spring element 41 may be directly supported by it. In particular, the annular flange 25 may have a greater diameter than the spring element 41.

FIG. 3 shows another embodiment of a seal configuration of an electrical circuit element 1 according to the invention.

The support element 35 adjacent to the interrupter 3 is positioned apart from the interrupter 3, such that a movement space 43 is formed between the wall section 24 and the adjacent support element 35. The movement space 43 runs annularly around the propulsion element 13. The interrupter 3 of the wall 9 has an elastically deviating wall section 45. The wall section 45 may be part of the wall section 24 having the opening 11, or be identical to it. The elastically deviating wall section 45 may deviate elastically into the movement space 43. The wall section 45 thus serves to absorb the movement of the propulsion element 13 in its resting position. The movement space 43 and the wall section 45 are part of the seal configuration 39. The wall section 45 may have an annular area 49 with a greater wall thickness than the rest of the wall 9 in order to increase its elasticity.

The adjacent support element 35 delimits the movement space 43 in a direction away from the interrupter 3. The adjacent support element 35 may be made, e.g., of part of a propulsion system (not shown). The adjacent support element 35 may, e.g., be part of a coil core surrounding the propulsion element 13. The wall 9 may have a receiving groove 47, which may run annularly around the opening, on the side facing the adjacent support element 35. The groove 47 may serve to fasten and align an adjacent support element 35. The groove 47 may form the annular space 49 with a reduced wall thickness compared to the rest of the wall 9.

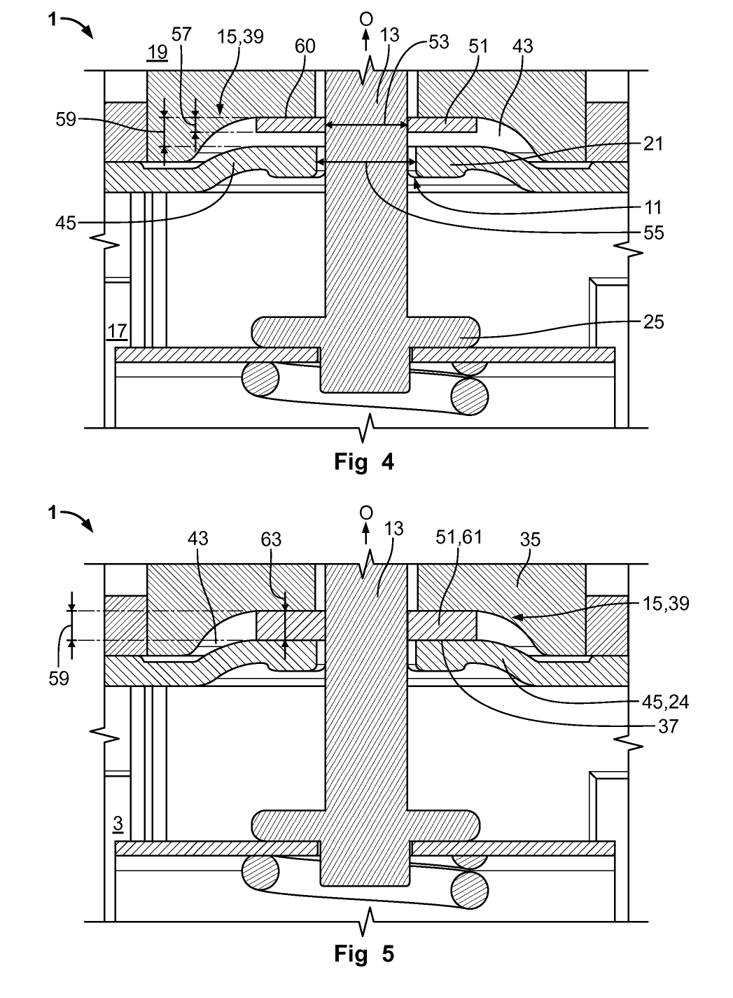

FIG. 4 shows part of another embodiment of an electrical circuit element 1 according to the invention. FIG. 4 shows the propulsion element 13 outside of its end position E.

The movement space 43 contains an annular secondary sealing element 51. The secondary sealing element 51 is penetrated by the propulsion element 13. An internal diameter 53 of the secondary sealing element 51 is smaller than an internal diameter 55 of the opening 11. The secondary sealing element 51 may be configured such that it tightly surrounds the propulsion element 13.

The secondary sealing element 51 may have a thickness 57 smaller than a width 59 of the movement space in a direction parallel to the opening direction O of the propulsion element 13. The secondary sealing element 51 is not connected with the propulsion element 13 in a fixed manner, and can move parallel to the opening direction O within the movement space 43. The secondary sealing element 51 is both part of the seal configuration 15 and of the damping configuration 39.

The functioning of the secondary sealing element 51 is described below: If the propulsion element 13 is in a switching position (not shown), the position of the secondary sealing element 51 is undefined within the movement space 43. If the contacts are opened and an arc (not shown) forms within the interrupter 3, the gas heated by the arc inside the interrupter 3 seeks to leave the interrupter 3 via the opening 11. The movement of the gas through the opening 11 can press the secondary sealing element 51 onto the inner side 60 of the movement space opposite the opening 11. The secondary sealing element 51 then abuts the inner side 60. Because the secondary sealing element 51 surrounds the propulsion element 13, the movement space 43, and thus the inside 17 of the interrupter 3 as well, is closed off from the area 19 outside of the interrupter 3.

The secondary sealing element 51 already seals the interrupter 3 before the propulsion element 13 reaches its end position E. If the propulsion element 13 moves quickly in the opening direction O, the flange 25 will collide with the stationary part 21. This moves the elastically deviating wall section 45 into the movement space 43, and may hit the secondary seal element 51. The secondary sealing element 51 may be made of an elastic material and effectively absorb the movement of the wall section 45. If the propulsion element 13 has reached its end position E (not shown), in addition to the seal provided by the secondary sealing element 51, which abuts the inner side 60, the interrupter 3 is additionally closed and sealed due to the fact that the annular flange 25 abuts the stationary part 21.

FIG. 5 shows part of another embodiment of a circuit element 1 according to the invention. The secondary sealing element 51 is formed as a press-fit element 61.

The thickness 63 of the press-fit element 61 corresponds at least to the width 59 of the movement space 43. If the thickness 63 of the press-fit element 61 is greater than the width 59 of the space 43, the press-fit element 61 is press-fit into the space 43 by the pressure exerted by the wall section 45, and abuts both the outer side 37 of the wall section 24 and the inner side 60 opposite the opening 11.

Because the press-fit element 61 tightly surrounds the propulsion element 13, it is a permanent seal that seals the interrupter 3 off from the area 19 outside of the interrupter 3 in every position of the propulsion element 13. The press-fit element 61 is thus part of the seal configuration 15. If the press-fit element 61 itself is made of elastically deformable material, it additionally serves as part of the damping configuration 39, as it effectively absorbs movement of the elastically deviating wall section 45 into the space 43. The wall section 45 directly abuts the press-fit element 61.

Because the press-fit element 61 is held by force in the space 43, it can form an additional guide for the propulsion element 13. This can improve the reliability of the electrical circuit element 1. The press-fit element 61 may be equipped, e.g., by means of its dimensions or material properties, such that it can only be moved perpendicularly to the opening direction O with increased force. In particular, it may be configured such that, at the first operation of an assembled electrical circuit element 1, imprecisions in production and/or assembly are compensated by the fact that, when the propulsion element 13 moves, the press-fit element 61 initially moves a certain distance in the movement space perpendicularly to the opening direction O, until the propulsion element 13 is arranged in a position that may be specified by additional elements of the electrical circuit element. The movability of the press-fit element 61 perpendicularly to the opening direction O thus ensures that the propulsion element can move without tension in and opposite the opening direction O during the further operation of the electrical circuit element 1.

The solution of the invention has the advantage that the seal configuration effectively seals the interrupter opening after the contacts have been separated. This keeps any plasma generated by an arc in the interrupter inside the interrupter. This prevents damage to the components of the electrical circuit element outside the interrupter. Because the plasma and the hot gas surrounding the plasma are limited to the volume of the interrupter, the increased pressure that builds up in the interrupter shortly after the formation of an arc also effectively facilitates the elimination of the arc. This interrupts the current flow and reduces any adverse effect on the components inside the interrupter.

What is claimed is:

1. An electrical circuit element, comprising:
an interrupter having contacts and an opening;
a propulsion element having an annular flange, being movable within the opening and functionally coupled to the contacts; and
a seal configuration having an annular ring surrounding the opening and abutting the annular flange.

2. The electrical circuit element according to claim 1, wherein the annular flange is integrally formed with the propulsion element.

3. The electrical circuit element according to claim 1, wherein the contacts are open in an end position.

4. The electrical circuit element according to claim 1, wherein the opening is formed in an outer wall of the interrupter.

5. The electrical circuit element according to claim 4, wherein the annular ring is part of the outer wall, and the annular ring protrudes into the interrupter.

6. The electrical circuit element according to claim 5, wherein the annular flange abuts a surface of the annular ring that is inside the interrupter.

7. The electrical circuit element according to claim 6, wherein the annular ring is an elastic material.

8. The electrical circuit element according to claim 7, wherein an annular wall section of the outer wall surrounds the annular ring, and the thickness of the annular wall section is less than the thickness of both the annular ring and the rest of the outer wall.

9. The electrical circuit element according to claim 8, wherein the annular wall section is an elastic material.

10. The electrical circuit element according to claim 7, wherein a support element abuts a surface of the annular ring that is outside the interrupter.

11. The electrical circuit element according to claim 7, wherein a support element is positioned to define a movement space between the support element and a surface of the annular ring that is outside the interrupter.

12. The electrical circuit element according to claim 11, further comprising an annular secondary sealing element positioned in the movement space.

13. The electrical circuit element according to claim 12, wherein the propulsion element extends through a hole in the secondary sealing element.

14. The electrical circuit element according to claim 13, wherein a diameter of the hole of the secondary sealing element is smaller than a diameter of the opening in the outer wall.

15. The electrical circuit element according to claim 14, wherein the thickness of the annular secondary sealing element is less than the thickness of the movement space.

16. The electrical circuit element according to claim 15, wherein the annular secondary sealing element is movable with respect to the propulsion element within the movement space.

17. The electrical circuit element according to claim 16, wherein the annular secondary sealing element abuts the support element when the propulsion element is in an end position.

18. The electrical circuit element according to claim 14, wherein the secondary sealing element is configured as a rigid press-fit element, held by force in the movement space.
